(19) United States
(12) Patent Application Publication
(10) Pub. No.: US 2026/0169844 A1
(43) Pub. Date: Jun. 18, 2026

(54) INFORMATION PROCESSING METHOD, TERMINAL, AND NON-TRANSITORY STORAGE MEDIUM

(71) Applicant: Beijing Zitiao Network Technology Co., Ltd., Beijing (CN)

(72) Inventors: Xiaoqi ZHAN, Beijing (CN); Lei QI, Beijing (CN)

(21) Appl. No.: 19/388,344

(22) Filed: Nov. 13, 2025

(30) Foreign Application Priority Data
Dec. 13, 2024 (CN) 202411847409.7

(51) Int. Cl. G06F 11/07

(52) U.S. Cl. CPC G06F 11/0757; G06F 2201/81

(57) ABSTRACT

The present disclosure provides an information processing method, a terminal, and a non-transitory storage medium. The information processing method includes: notifying an application process of running a component and sending component information to a component running monitoring manager; in response to that a component running completion notification is not received within a first preset time, sending component running timeout notification information to the application process; querying a communication monitoring module about communication information of a key thread of the application process by a communication sub-thread of the application process, the communication information including a server process responding to communication and a communication time; in response to that the communication time exceeds a preset threshold, sending communication timeout notification information to an abnormality checking and killing manager by the communication sub-thread; and determining whether to check and kill the server process by the abnormality checking and killing manager.

### CROSS-REFERENCE TO RELATED APPLICATION

This application claims the priority to and benefits of the Chinese Patent Application No. 202411847409.7, which was filed on December 13, 2024. The aforementioned patent application is hereby incorporated by reference in its entirety.

### TECHNICAL FIELD

The present disclosure relates to an information processing method, a terminal, and a non-transitory storage medium.

### BACKGROUND

In an Android system, for example, when a client process and a server process communicate (for example, binder communication) with each other, when an abnormality occurs to the server process, such as key thread lagging and freezing, a response message cannot be returned to a client in time, which may result in a poor user experience. Further improvements in this regard are desired.

### SUMMARY

In order to solve the existing problems, the present disclosure provides an information processing method, a terminal, and a non-transitory storage medium.

The present disclosure adopts the following technical solutions.

An embodiment of the present disclosure provides an information processing method, and the information processing method includes: notifying an application process of running a component and sending corresponding component information to a component running monitoring manager by a system; when a component running completion notification is not received within a first preset time, sending component running timeout notification information to the application process by the component running monitoring manager; querying a communication monitoring module about communication information of a key thread of the application process by a communication sub-thread of the application process based on the component running timeout notification information, the communication information including a server process responding to communication and a communication time; when the communication time exceeds a preset threshold, sending communication timeout notification information to an abnormality checking and killing manager by the communication sub-thread; and determining whether to check and kill the server process by the abnormality checking and killing manager based on the communication timeout notification information and checking and killing conditions.

Another embodiment of the present disclosure provides an information processing apparatus, including: a system server module configured for notifying an application process of running a component and sending corresponding component information to a component running monitoring manager; a component running management module configured for enabling the component running monitoring manager to send component running timeout notification information to the application process when a component running completion notification is not received within a first preset time; a communication information query module configured for enabling a communication sub-thread of the application process to query a communication monitoring module about communication information of a key thread of the application process based on the component running timeout notification information, the communication information including a server process responding to communication and a communication time; a communication timeout notification module configured for enabling the communication sub-thread to send communication timeout notification information to an abnormality checking and killing manager when the communication time exceeds a preset threshold; and a checking and killing module configured for enabling the abnormality checking and killing manager to determine whether to check and kill the server process based on the communication timeout notification information and checking and killing conditions.

In some embodiments, the present disclosure provides a terminal, including: at least one memory and at least one processor; the at least one memory is configured for storing program codes, and the at least one processor is configured for calling the program codes stored in the at least one memory to execute the above information processing method.

In some embodiments, a non-transitory storage medium is provided, being configured for storing program codes which are configured for executing the above information processing method.

The present disclosure may detect abnormalities in the server process and restart the server process to recover a scene, without needing to restart a system for recovery, thereby significantly enhancing the system stability and user experience.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a flowchart of an information processing method according to embodiments of the present disclosure.

FIG. 2 shows an abnormality monitoring framework diagram according to some embodiments of the present disclosure.

FIG. 3 shows a flowchart of the information processing method according to some embodiments of the present disclosure.

FIG. 4 shows a processing flowchart at an application process side according to some embodiments of the present disclosure.

FIG. 5 shows a running logic diagram of a component running monitoring manager according to some embodiments of the present disclosure.

FIG. 6 shows a running logic diagram of a communication monitoring module according to some embodiments of the present disclosure.

FIG. 7 shows a running logic diagram of an abnormality checking and killing manager according to some embodiments of the present disclosure.

FIG. 8 is a partial block diagram of an information processing apparatus according to another embodiment of the present disclosure.

FIG. 9 is a schematic structural diagram of an electronic device according to embodiments of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term "including" and variations thereof used in this article are open-ended inclusion, namely "including but not limited to". The term "based on" refers to "at least partially based on". The term "one embodiment" means "at least one embodiment"; the term "another embodiment" means "at least one other embodiment"; and the term "some embodiments" means "at least some embodiments". Relevant definitions of other terms may be given in the description hereinafter.

It should be noted that concepts such as "first" and "second" mentioned in the present disclosure are only used to distinguish different apparatuses, modules or units, and are not intended to limit orders or interdependence relationships of functions performed by these apparatuses, modules or units.

It should be noted that modifications of "one" and "more" mentioned in the present disclosure are schematic rather than restrictive, and those skilled in the art should understand that unless otherwise explicitly stated in the context, it should be understood as "one or more".

The names of messages or information interacted among a plurality of apparatuses in the embodiments of the present disclosure are for illustrative purposes only and are not intended to limit the scope of such messages or information.

In an Android system, for example, when a client process and a server process communicate (for example, binder communication) with each other, if an abnormality occurs to the server process, such as key thread blocking and sticking, a response message cannot be returned to a client in time, which may result in a poor user experience. For example, if a foreground application is communicating with a background server process, but never receives a response from the server, it may cause the foreground application to lag or freeze, and the like. In such cases, a prompt box will generally pop up to ask the user about whether to close the process. For another example, when the communication between a core system process (such as a system server process) and a certain application process has been always blocked, a large number of threads in the system server process may be caused to be blocked due to a waiting for locks and the like. At this moment, the process cannot respond to requests from other client processes, leading to system crashes, and even more seriously, system restarts.

When communication between a key thread of a certain application process and a server process is blocked, the Android system usually pops up a prompt box to request to close the application process. However, because the root cause lies in an abnormality at the server, the server process remains in an abnormality state at this time. When the application process accesses the server again after restarting next time or when other applications access the server, blocking will still occur. Yet the Android system has no solutions for detecting such server processes and immediately recovering them. There are many reasons for abnormalities in the server processes; and typical ones include deadlocks occurring inside the processes, erroneous freezing of the process, memory leaks occurring inside the processes, entering infinite loops, and the like. In the Android system, although a watchdog-like monitoring strategy has been implemented for the running of the key thread in the system server process, which can effectively detect and identify whether abnormalities have occurred in the key thread of the system server process, there are many server processes in the system, and the roles of client and server processes are relative. When a server process accesses the client because of business requirements, the roles of the client and server processes will be interchanged, with the original client becoming the server.

At present, the monitoring strategy of the Android system has two problems. One is that when it is detected and identified that the key thread of the application is blocked, it will only pop up a box to request closing the client application process, without caring whether the server process has an abnormality at this time. Second, there is no universal server abnormality monitoring solution. The watchdog monitoring solution mentioned above is only applicable to the interior of the system server process. This solution is not universal and transplantable, and cannot be transplanted to other processes, because as it is completely coupled with specific business logic. In addition, some server processes have closed-sources themselves, do not provide source codes, and do not have conditions of adding any code inside the processes. In addition to the watchdog solution, there are also similar state machine solutions, all of which have common defects: they are completely coupled with businesses and lack universality.

Based on the above problems, it is necessary to design a relatively universal abnormality monitoring solution, which can accurately identify whether various server processes are abnormal without caring about the specific implementation logic inside the processes.

At present, the manner for detecting whether a process is blocked and stuck, and the like is basically concentrated on the interior of the process, generally implemented by means of adding methods such as a state machine and a watchdog, and the like. Although this manner can relatively accurately identify whether the key logic of the key thread has an abnormality, it is not universal. This solution cannot be compatible with and identify whether a plurality of different processes are blocked and have abnormalities, and the like, because these solutions are completely coupled with the internal logic of the process. Therefore, it is necessary to design a universal solution which can detect and identify whether the key logic of the server process has an abnormality (such as blocking, freezing, etc.).

Because a main purpose of the server process is to provide a service to the client process, in the Android system, the client process and the server process communicate via mechanisms, such as binder. In the present disclosure, whether the server process has an abnormality is identified by monitoring whether binder communication between the key thread of the client process and the server process is blocked. When it is identified that the binder communication is blocked for a long time, when it exceeds a predetermined threshold, it is considered that the server process has an abnormality (blocking, freezing, and the like). In this case, the server process needs to be restarted for recovery.

Firstly, this involves accurate monitoring of communication information of the key thread in the application process: there are a large number of threads being in communication in each process, and it is necessary to conduct statistics on communication time consumption of the key thread in the process. Because it is necessary to calculate a system time at least twice for each communication to obtain the communication time consumption for the current communication, it is necessary to minimize the impact of a method for obtaining the system time on system performance. In addition, it involves the timing for accurately triggering the detection of the abnormality in the server process: communication occurs at all times, and not all blockages in key thread communication will necessarily affect user experience. In order to further reduce the impact caused by the monitoring solution itself on the performance, it is necessary to combine with a component running mechanism of the Android system to start the detection of triggering timing. When the key component is started to run for a certain time, the detection needs to be triggered to minimize the impact on the performance. In addition, after an abnormality checking and killing manager identifies that the server process has an abnormality, it is necessary to consider various factors, such as a running scene of the process, whether there is communication with other processes, whether there are a plurality of dependent processes, and whether other processes will be restarted, so as to confirm whether the server process may be killed according to a plurality of factors.

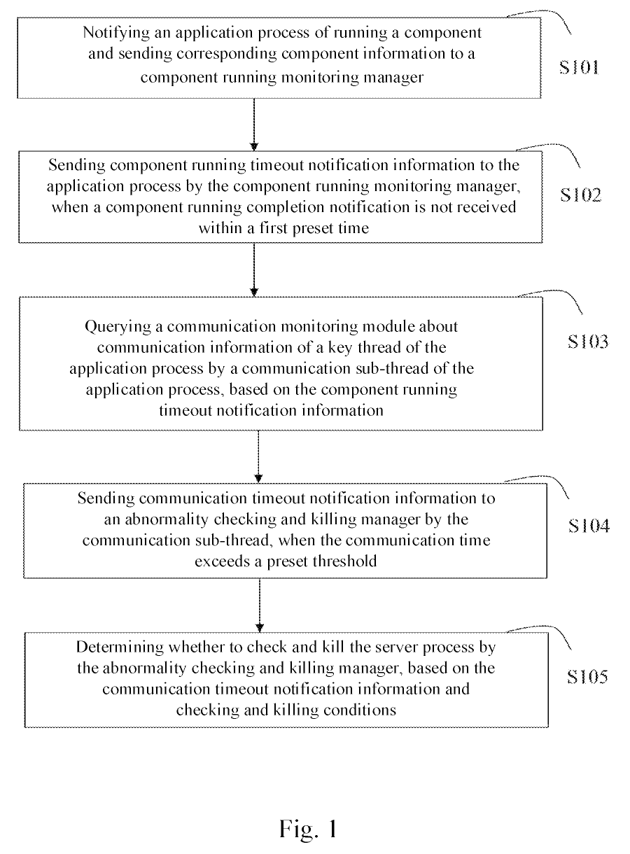

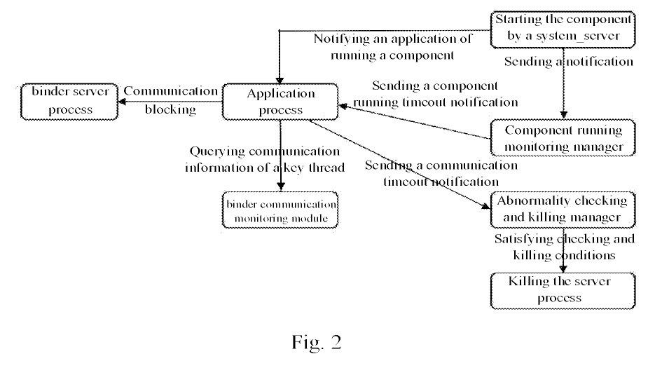

FIG. 1 provides a flowchart of an information processing method according to embodiments of the present disclosure , and FIG. 2 shows a monitoring framework diagram according to some embodiments. The information processing method of the present disclosure may include step S101: notifying an application process of running a component by a system and sending corresponding component information to a component running monitoring manager. In some embodiments, in an Android system, the running of the application process cannot be separated from the support of system components. Here, the components refer to input events, broadcasts, services, provider, activity, and the like, and the start and running logic of the components are controlled by a system server in a server process. As shown in FIG. 2, the overall monitoring framework involves the interaction of three processes: a system server process, an application process and a server process. In some embodiments, when the system server process notifies the application process of running the component, a corresponding component message will be sent to the component running monitoring manager simultaneously to inform a component type and a first application process to which the component is sent, and the like. In some embodiments, the component running monitoring manager may set a corresponding timeout message according to the component type.

In some embodiments, the method of the present disclosure may further include step S102: when a component running completion notification is not received within a first preset time, sending component running timeout notification information to the application process by the component running monitoring manager. In some embodiments, the application process sends one component running completion notification to the component running monitoring manager each time after one lifecycle method of the component is executed. If a key thread of the application process is blocked for a long time, it cannot send the completion notification to the component running monitoring manager in a timely manner. In this case, the component running monitoring manager sends one component running timeout notification to the application process, which is responded to by a communication sub-thread of the application process. In some embodiments, the first preset time may be set by the system and may also be modified by a user.

In some embodiments, the method of the present disclosure may further include step S103: querying a communication monitoring module about communication information of a key thread of the application process by a communication sub-thread of the application process based on the component running timeout notification information, the communication information including a server process responding to communication and a communication time. In some embodiments, the communication sub-thread of the application process queries the communication monitoring module about whether the key thread of the application process is communicating, as well as the server process responding to the current communication.

In some embodiments, the method of the present disclosure may further include step S104: when the communication time exceeds a preset threshold, sending communication timeout notification information to an abnormality checking and killing manager by the communication sub-thread. When the communication time exceeds the preset threshold, it indicates that the application process is blocked due to communication with the server process, and at this moment, the communication sub-thread sends a piece of communication timeout notification information to the abnormality checking and killing manager. In some embodiments, the communication timeout notification information includes a communication time, a server process responding to communication, whether the server process is located in a foreground, and the like.

In some embodiments, the method of the present disclosure may further include step S105: determining whether to check and kill the server process by the abnormality checking and killing manager based on the communication timeout notification information and checking and killing conditions. In some embodiments, the abnormality checking and killing manager judges whether the server process satisfies the checking and killing conditions according to the communication timeout notification information. When the checking and killing conditions are satisfied, the server process will be killed to achieve the purpose of recovery. In some embodiments, the checking and killing conditions include a system load, a running scene of the application process, and/or whether the server process communicates with other processes. For example, when the system load is relatively heavy, it may be due to the load issue, and there is no need to kill the server process; in some preset scenes, the server process may not be killed; and when the server process is communicating with other processes, the server process may not be killed.

In an embodiment of the present disclosure, when an application starts running a certain component, a component running manager begins to monitor a lifecycle method in which the component runs and sends a notification to the application process at a corresponding time point. The sub-thread of the application process responds to the request and queries the communication monitoring module about communication information of the key thread. The communication monitoring module of the present disclosure accurately identifies and monitors all communication information of the key thread in the application process, including communication start time and end time, a corresponding thread number, and the like. In addition, the abnormality checking and killing manager determines whether the corresponding server process may be killed according to server configuration and internal logic. When it is determined that the server process may be killed, by killing the server process and restarting the server process, the application process recovers the blocking scene. On one hand, the probability of application ANR (app not responding) is reduced, and on the other hand, the running of the server process is recovered. When the application runs the component, in response to that the key thread is blocked in communication for a long time, the solution of the present disclosure can realize recovery before the application experiences ANR, reducing the probability of ANR and improving application stability. In addition, most of the server processes in the system do not have abnormality detection and recovery mechanisms themselves. Once an abnormality occurs, it may lead to serious consequences, and the system can only be restored by restarting, resulting in a very poor user experience. For example, when a certain server process is abnormally frozen and cannot be recovered, or a deadlock occurs inside the process, and the like, after these situations occur, communication between any application and the server process will be blocked and fail, with no means of recovery. By means of the solution of the present disclosure, an abnormality in the server process may be detected and the server process may restarted to recover the scene. There is no need to restart the system for recovery, which greatly improves system stability and user experience.

In some embodiments, the communication monitoring module runs in the application process, and the component running monitoring manager and the abnormality checking and killing manager run in the system server process.

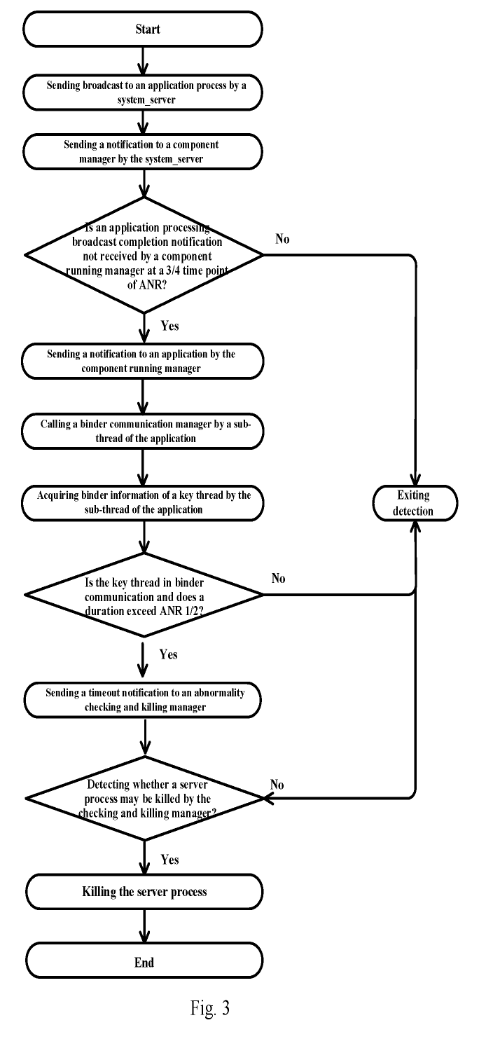

With reference to FIG. 3, the whole running monitoring flow will be described by the process of a certain application process responding to a certain broadcast component, and ANR herein is an abbreviation of "app not responding", and "system_server" herein is a service process of the Android system. In the specific embodiment of FIG. 3, the first preset time is 3/4 of the ANR duration, a communication manner is binder communication, and the preset threshold is 1/2 of the ANR duration. It should be understood that these values are illustrative and are not intended to limit the present disclosure. In some embodiments, the ANR duration is 5s, 10s or 20s, and the like. It should be understood that this is illustrative only and is not intended to limit the present disclosure.

In some embodiments, the information processing method of the present disclosure further includes: determining the key thread in the application process; labeling the key thread; and notifying the communication monitoring module of the labeled key thread. A plurality of sub-threads generally run in each application process, and there may be hundreds of threads in a complex application. The user experience will be directly affected only when an abnormality occurs in the running of the key thread. For example, in Android applications, threads such as main and RenderThread are mainly key threads. By labeling threads at their entries and notifying the communication monitoring manager, the communication monitoring manager only conducts statistics on communication time consumption of the labeled threads.

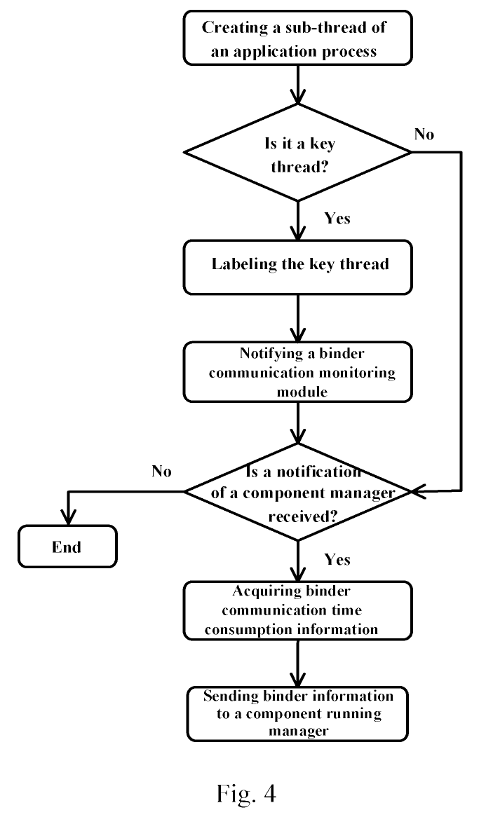

With reference to FIG. 4, when the sub-thread of the application process is created, it is firstly determined whether it is the key thread, which may be set by default and may also be changed by a user. Thereafter, the threads determined as the key threads are labeled and the communication monitoring module is notified. Thereafter, when the notification from the component running monitoring manager is received, corresponding communication time consumption information is obtained.

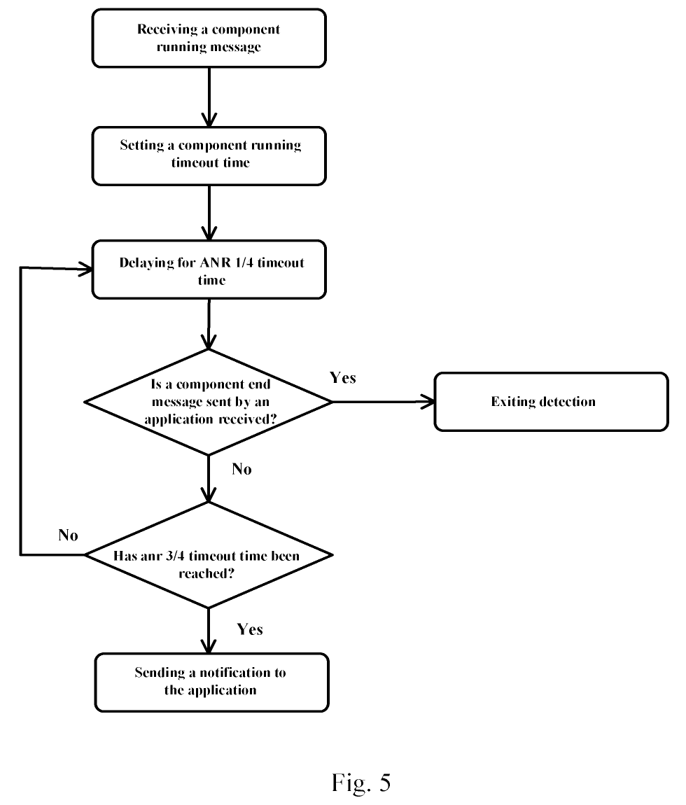

In some embodiments, the information processing method of the present disclosure further includes: when the component information is received, setting a component running timeout time by the component running monitoring manager; when a second preset time is exceeded, determining whether the component running completion notification is received, the second preset time being less than the first preset time; when the component running completion notification is not received, determining whether the first preset time is reached; and when the first preset time is not reached, delaying for the second preset time each time and determining whether the component running completion notification is received, and when the component running completion notification is not received within the first preset time, sending the component running timeout notification to the application process by the component running monitoring manager. With reference to FIG. 5, FIG. 5 shows a running framework of the component running monitoring manager which runs in the system server process to trigger a corresponding timeout monitoring mechanism in combination with the component type. It detects whether a component execution end message sent by the application process is received at regular intervals, exits the detection when a component completion message is received within 3/4 of the ANR timeout time, otherwise sends one component running timeout notification message to the application process to notify the application process of querying whether it is blocked on a communication link. In FIG. 5, when the component running timeout time is set, different timeout times may be set based on different component types, and the running timeout time is illustratively set to be 3/4 of ANR in FIG. 5.

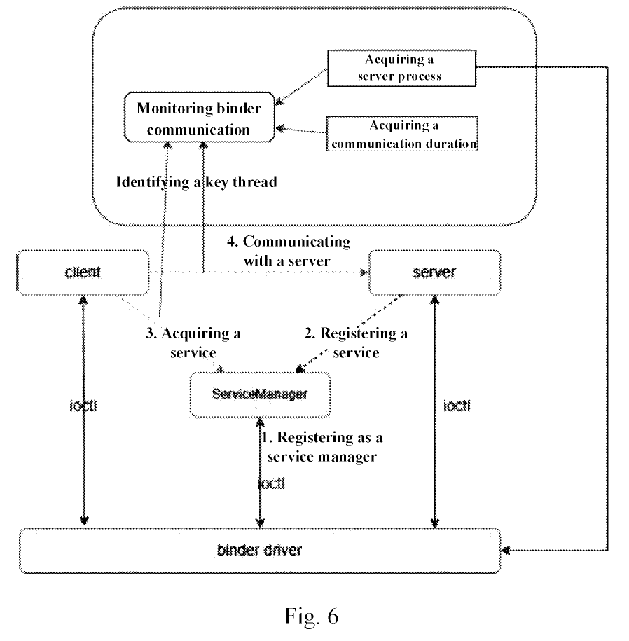

With reference to FIG. 6, FIG. 6 shows a running framework of the communication monitoring module. An implementation flow of a binder communication monitoring module will be described below: a ServiceManager process registers with a binder driver to become a service manager; a binder server process registers with the ServiceManager process to become a binder server in virtue of the binder driver; a client application process obtains a binder proxy of the binder server in the client process from the ServiceManager process in virtue of the binder driver; the client application process performs binder communication with the binder server process by the obtained binder proxy; and a binder communication monitoring module identifies whether a thread currently participating in communication is a key thread, when it is the key thread, start time and end time of the binder communication at this moment are recorded (when the binder communication is not ended, only the start time of the binder communication needs to be recorded), and simultaneously, a binder server process ID needs to be obtained from the binder driver, these data are stored in one ringbuffer of the client application process, and a method is provided to be called by an internal module of the application process.

As shown above, in addition to only monitoring the binder communication information of the key thread, optimization may also be performed in obtaining the system time. The method of directly reading a CPU clock of the system in the present disclosure achieves an optimization effect. Compared with system calls for obtaining the system time, the performance is improved by more than doubled.

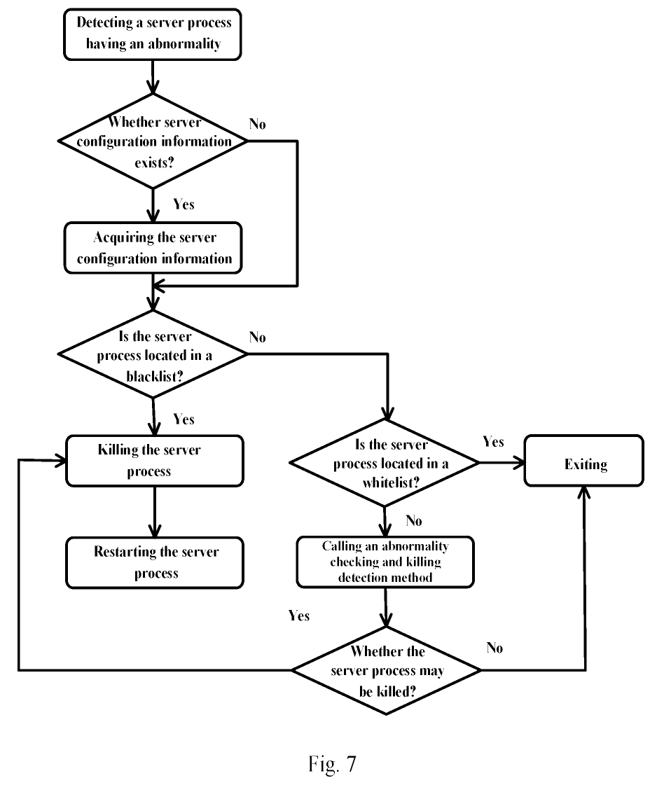

In some embodiments, determining whether to check and kill the server process by the abnormality checking and killing manager based on the communication timeout notification information and checking and killing conditions, includes: determining whether server configuration information exists, the server configuration information including a blacklist and/or a whitelist; when it is determined that the server configuration information exists, obtaining the server configuration information; determining whether the server process is located in the blacklist; when the server process is located in the blacklist, checking and killing the server process and restarting the server process; when the server process is not located in the blacklist, determining whether the server process is located in the whitelist; and when the server process is not located in the whitelist, determining whether to check and kill the server process based on the communication timeout notification information and the checking and killing conditions. In some embodiments, an algorithm for detection is implemented inside the abnormality checking and killing manager, which takes into account various factors, such as a system load, a running scene of the current application, whether it is located in a foreground, and whether the server is communicating with other processes again. With reference to FIG. 7, in order to improve the flexibility and accuracy, the system supports the delivery of process whitelists and blacklists through server configurations. When the abnormality checking and killing manager receives an abnormal server process that needs to be detected, it needs to obtain server configuration information, and then detects whether a corresponding process is in the blacklist or whitelist. The process in the blacklist is directly killed, and the process in the whitelist is directly skipped.

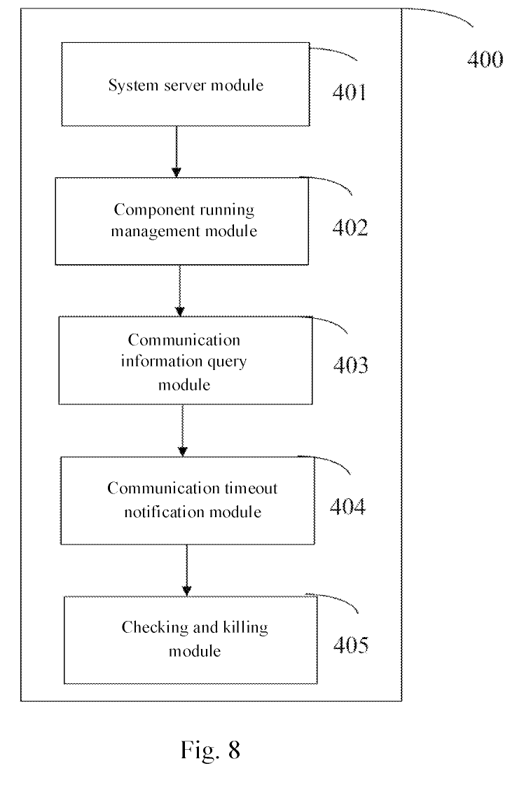

An embodiment of the present disclosure further provides an information processing apparatus 400. FIG. 8 shows the information processing apparatus 400 according to some embodiments. The information processing apparatus 400 includes a system server module 401, a component running management module 402, a communication information query module 403, a communication timeout notification module 404, and a checking and killing module 405. In some embodiments, the system server module 401 is configured for notifying an application process of running a component and sending corresponding component information to a component running monitoring manager. In some embodiments, the component running management module 402 is configured for enabling the component running monitoring manager to send component running timeout notification information to the application process by when a component running completion notification is not received within a first preset time,. In some embodiments, the communication information query module 403 is configured for enabling a communication sub-thread of the application process to query a communication monitoring module about communication information of a key thread of the application process based on the component running timeout notification information, and the communication information includes a server process responding to communication and a communication time. In some embodiments, the communication timeout notification module 404 is configured for enabling the communication sub-thread to send communication timeout notification information to an abnormality checking and killing manager when the communication time exceeds a preset threshold. In some embodiments, the checking and killing module 405 is configured for enabling the abnormality checking and killing manager to determine whether to check and kill the server process based on the communication timeout notification information and checking and killing conditions.

It should be understood that the contents described with respect to the information processing method are also applicable to the information processing apparatus 400 herein, and will not be described in detail herein for the sake of simplicity.

In some embodiments, the communication monitoring module runs in the application process, and the component running monitoring manager and the abnormality checking and killing manager run in the system server process. In some embodiments, the component information includes the component type and the first application process running the component, the communication timeout notification information includes the communication time, the server process responding to communication, and whether the server process is located in the foreground, and the checking and killing conditions include the system load, the running scene of the application process, and/or whether the server process communicates with other processes. In some embodiments, the application process sends one component running completion notification to the component running monitoring manager each time after one lifecycle method of the component is executed. In some embodiments, the information processing apparatus further includes: a key thread determination module configured for determining the key thread in the application process; a labeling module configured for labeling the key thread; and a notification module configured for notifying the communication monitoring module of the labeled key thread. In some embodiments, the information processing apparatus further includes: a timeout time setting module configured for enabling the component running monitoring manager to set a component running timeout time when the component information is received; a notification receiving determination module configured for determining whether the component running completion notification is received when a second preset time less than the first preset time is exceeded; a timeout determination module configured for determining whether the first preset time is reached when the component running completion notification is not received; and the notification receiving determination module further configured for: delaying for the second preset time each time and determining whether the component running completion notification is received when the first preset time is not reached. The component running monitoring manager will send the component running timeout notification to the application process when the component running completion notification is not received within the first preset time. In some embodiments, when the communication monitoring module is queried about the communication information of the key thread of the application process by the communication sub-thread of the application process, the communication time is obtained by means of reading a clock of a system central processing unit. In some embodiments, determining whether to check and kill the server process by the abnormality checking and killing manager based on the communication timeout notification information and checking and killing conditions includes: determining whether server configuration information exists, the server configuration information including a blacklist and/or a whitelist; when it is determined that the server configuration information exists, obtaining the server configuration information; determining whether the server process is located in the blacklist; when the server process is located in the blacklist, checking and killing the server process and restarting the server process; when the server process is not located in the blacklist, determining whether the server process is located in the whitelist; and when the server process is not located in the whitelist, determining whether to check and kill the server process based on the communication timeout notification information and the checking and killing conditions.

In addition, the present disclosure further provides a terminal, including: at least one memory and at least one processor; the memory is configured for storing program codes, and the processor is configured for calling the program codes stored in the memory to execute the information processing method described above.

In addition, the present disclosure further provides a non-transitory computer storage medium storing program codes which are configured for executing the information processing method described above.

The information processing method and apparatus of the present disclosure are described above based on the embodiments and application examples. In addition, the present disclosure further provides a terminal and a storage medium, which are described below.

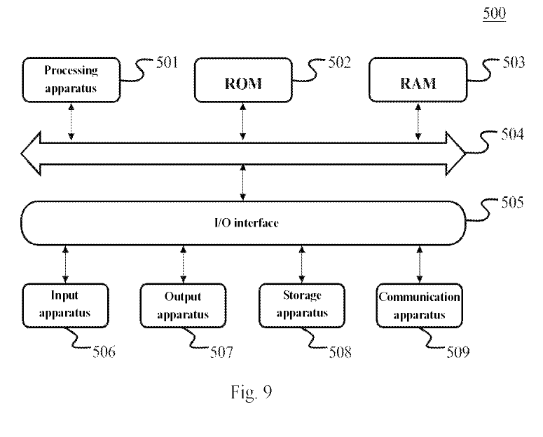

Referring to FIG. 5, FIG. 5 illustrates a schematic structural diagram of an electronic device (for example a terminal device or a sever) 500 suitable for implementing some embodiments of the present disclosure. The terminal device in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), or the like, and fixed terminals such as a digital TV, a desktop computer, or the like. The electronic device illustrated in FIG. 9 is merely an example, and should not pose any limitation to the functions and the range of use of the embodiments of the present disclosure.

As illustrated in FIG. 5, the electronic device 500 may include a processing apparatus 501 (e.g., a central processing unit, a graphics processing unit, etc.), which can perform various suitable actions and processing according to a program stored in a read-only memory (ROM) 502 or a program loaded from a storage apparatus 508 into a random-access memory (RAM) 503. The RAM 503 further stores various programs and data required for operations of the electronic device 500. The processing apparatus 501, the ROM 502, and the RAM 503 are interconnected by means of a bus 504. An input/output (I/O) interface 505 is also connected to the bus 504.

Usually, the following apparatus may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a loudspeaker, a vibrator, or the like; a storage apparatus 508 including, for example, a magnetic tape, a hard disk, or the like; and a communication apparatus 509. The communication apparatus 509 may allow the electronic device 500 to be in wireless or wired communication with other devices to exchange data. While FIG. 5 illustrates the electronic device 500 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a computer-readable medium. The computer program includes program codes for performing the methods shown in the flowcharts. In such embodiments, the computer program may be downloaded online through the communication apparatus 509 and installed, or may be installed from the storage apparatus 508, or may be installed from the ROM 502. When the computer program is executed by the processing apparatus 501, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to perform the above method according the embodiments of the disclosure.

The computer program codes for performing the operations of the present disclosure may be written in one or more programming languages or a combination thereof. The above-mentioned programming languages include object-oriented programming languages such as Java, Smalltalk, C++, and also include conventional procedural programming languages such as the “C” programming language or similar programming languages. The program code may be executed entirely on the user’s computer, partly on the user’s computer, as a stand-alone software package, partly on the user’s computer and partly on a remote computer, or entirely on the remote computer or server. In the scenario related to the remote computer, the remote computer may be connected to the user’s computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. Among them, the name of the unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more examples of the present disclosure, an information processing method is provided, and the information processing method includes: notifying an application process of running a component and sending corresponding component information to a component running monitoring manager by a system; when a component running completion notification is not received within a first preset time, sending component running timeout notification information to the application process by the component running monitoring manager; querying a communication monitoring module about communication information of a key thread of the application process by a communication sub-thread of the application process based on the component running timeout notification information, the communication information including a server process responding to communication and a communication time; when the communication time exceeds a preset threshold, sending communication timeout notification information to an abnormality checking and killing manager by the communication sub-thread; and determining whether to check and kill the server process by the abnormality checking and killing manager based on the communication timeout notification information and checking and killing conditions.

According to one or more embodiments of the present disclosure, the communication monitoring module runs in the application process, and the component running monitoring manager and the abnormality checking and killing manager run in a system server process.

According to one or more embodiments of the present disclosure, the component information includes a component type and a first application process running the component, the communication timeout notification information includes the communication time, the server process responding to communication, and whether the server process is located in a foreground, and the checking and killing conditions include at least one selected from a group consisting of a system load, a running scene of the application process, and whether the server process communicates with other processes.

According to one or more embodiments of the present disclosure, the application process sends one component running completion notification to the component running monitoring manager each time after one lifecycle method of the component is executed.

According to one or more embodiments of the present disclosure, the information processing method further includes: determining the key thread in the application process; labeling the key thread; and notifying the communication monitoring module of the labeled key thread.

According to one or more embodiments of the present disclosure, the information processing method further includes: when the component information is received, setting a component running timeout time by the component running monitoring manager; when a second preset time less than the first preset time is exceeded, determining whether the component running completion notification is received,; when the component running completion notification is not received, determining whether the first preset time is reached; and when the first preset time is not reached, delaying for the second preset time each time, determining whether the component running completion notification is received, and when the component running completion notification is not received within the first preset time, sending the component running timeout notification to the application process by the component running monitoring manager.

According to one or more embodiments of the present disclosure, when the communication monitoring module is queried about the communication information of the key thread of the application process by the communication sub-thread of the application process, the communication time is obtained by means of reading a clock of a system central processing unit.

According to one or more embodiments of the present disclosure, determining whether to check and kill the server process by the abnormality checking and killing manager based on the communication timeout notification information and checking and killing conditions, includes: determining whether server configuration information exists, the server configuration information including a blacklist and/or a whitelist; when it is determined that the server configuration information exists, obtaining the server configuration information; determining whether the server process is located in the blacklist; when the server process is located in the blacklist, checking and killing the server process and restarting the server process; when the server process is not located in the blacklist, determining whether the server process is located in the whitelist; and when the server process is not located in the whitelist, determining whether to check and kill the server process based on the communication timeout notification information and the checking and killing conditions.

According to one or more embodiments of the present disclosure, an information processing apparatus is provided, and the information processing apparatus includes: a system server module configured for notifying an application process of running a component and sending corresponding component information to a component running monitoring manager; a component running management module configured for enabling the component running monitoring manager to send component running timeout notification information to the application process when a component running completion notification is not received within a first preset time; a communication information query module configured for enabling a communication sub-thread of the application process to query a communication monitoring module about communication information of a key thread of the application process based on the component running timeout notification information, the communication information including a server process responding to communication and a communication time; a communication timeout notification module configured for enabling the communication sub-thread to send communication timeout notification information to an abnormality checking and killing manager when the communication time exceeds a preset threshold; and a checking and killing module configured for enabling the abnormality checking and killing manager to determine whether to check and kill the server process based on the communication timeout notification information and checking and killing conditions.

According to one or more embodiments of the present disclosure, a terminal is provided, including: at least one memory and at least one processor; the at least one memory is configured for storing program codes, and the at least one processor is configured for calling the program codes stored in the at least one memory to execute the method according to any one described above.

According to one or more embodiments of the present disclosure, a non-transitory storage medium is provided, being configured for storing program codes which are configured for executing the method described above.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims. Specific manners of operations performed by the modules in the apparatus in the above embodiment have been described in detail in the embodiments regarding the method, which will not be explained and described in detail herein again.

1. An information processing method, comprising:
notifying an application process of running a component and sending component information to a component running monitoring manager;
in response to that a component running completion notification is not received within a first preset time, sending component running timeout notification information to the application process by the component running monitoring manager;
querying a communication monitoring module about communication information of a key thread of the application process by a communication sub-thread of the application process based on the component running timeout notification information, the communication information comprising a server process responding to communication and a communication time;
in response to that the communication time exceeds a preset threshold, sending communication timeout notification information to an abnormality checking and killing manager by the communication sub-thread; and
determining whether to check and kill the server process by the abnormality checking and killing manager based on the communication timeout notification information and checking and killing conditions.

2. The information processing method according to claim 1, wherein the communication monitoring module runs in the application process, and the component running monitoring manager and the abnormality checking and killing manager run in a system server process.

3. The information processing method according to claim 1, wherein the component information comprises a component type and a first application process running the component, the communication timeout notification information comprises the communication time, the server process responding to communication, and whether the server process is located in a foreground, and the checking and killing conditions comprise at least one selected from a group consisting of a system load, a running scene of the application process, and whether the server process communicates with other processes.

4. The information processing method according to claim 1, wherein the application process sends one component running completion notification to the component running monitoring manager each time after one lifecycle method of the component is executed.

5. The information processing method according to claim 1, further comprising:
determining the key thread in the application process;
labeling the key thread; and
notifying the communication monitoring module of the key thread which is labelled.

6. The information processing method according to claim 1, further comprising:
in response to receive the component information, setting a component running timeout time by the component running monitoring manager;
in response to that a second preset time is exceeded, determining whether the component running completion notification is received, the second preset time being less than the first preset time;
in response to not receive the component running completion notification, determining whether the first preset time is reached; and
in response to that the first preset time is not reached, delaying for the second preset time each time and determining whether the component running completion notification is received, and when the component running completion notification is not received within the first preset time, sending the component running timeout notification to the application process by the component running monitoring manager.

7. The information processing method according to claim 1, wherein in response to that the communication monitoring module is queried about the communication information of the key thread of the application process by the communication sub-thread of the application process, the communication time is obtained by means of reading a clock of a system central processing unit.

8. The information processing method according to claim 1, wherein determining whether to check and kill the server process by the abnormality checking and killing manager based on the communication timeout notification information and checking and killing conditions, comprises:
determining whether server configuration information exists, the server configuration information comprising a blacklist and/or a whitelist;
in response to that it is determined that the server configuration information exists, obtaining the server configuration information;
determining whether the server process is located in the blacklist;
in response to that the server process is located in the blacklist, checking and killing the server process and restarting the server process;
in response to that the server process is not located in the blacklist, determining whether the server process is located in the whitelist; and
in response to that the server process is not located in the whitelist, determining whether to check and kill the server process based on the communication timeout notification information and the checking and killing conditions.

9. A terminal, comprising:
at least one memory; and
at least one processor,
wherein the at least one memory is configured to store program codes, and the at least one processor is configured to call the program codes stored in the at least one memory to execute an information processing method,
wherein the information processing method comprises:
notifying an application process of running a component and sending component information to a component running monitoring manager;
in response to that a component running completion notification is not received within a first preset time, sending component running timeout notification information to the application process by the component running monitoring manager;
querying a communication monitoring module about communication information of a key thread of the application process by a communication sub-thread of the application process based on the component running timeout notification information, the communication information comprising a server process responding to communication and a communication time;
in response to that the communication time exceeds a preset threshold, sending communication timeout notification information to an abnormality checking and killing manager by the communication sub-thread; and
determining whether to check and kill the server process by the abnormality checking and killing manager based on the communication timeout notification information and checking and killing conditions.

10. The terminal according to claim 9, wherein the communication monitoring module runs in the application process, and the component running monitoring manager and the abnormality checking and killing manager run in a system server process.

11. The terminal according to claim 9, wherein the component information comprises a component type and a first application process running the component, the communication timeout notification information comprises the communication time, the server process responding to communication, and whether the server process is located in a foreground, and the checking and killing conditions comprise at least one selected from a group consisting of a system load, a running scene of the application process, and whether the server process communicates with other processes.

12. The terminal according to claim 9, wherein the application process sends one component running completion notification to the component running monitoring manager each time after one lifecycle method of the component is executed.

13. The terminal according to claim 9, further comprising:
determining the key thread in the application process;
labeling the key thread; and
notifying the communication monitoring module of the key thread which is labelled.

14. The terminal according to claim 9, further comprising:
in response to receive the component information, setting a component running timeout time by the component running monitoring manager;
in response to that a second preset time is exceeded, determining whether the component running completion notification is received, the second preset time being less than the first preset time;
in response to not receive the component running completion notification, determining whether the first preset time is reached; and
in response to that the first preset time is not reached, delaying for the second preset time each time and determining whether the component running completion notification is received, and when the component running completion notification is not received within the first preset time, sending the component running timeout notification to the application process by the component running monitoring manager.

15. The terminal according to claim 9, wherein in response to that the communication monitoring module is queried about the communication information of the key thread of the application process by the communication sub-thread of the application process, the communication time is obtained by means of reading a clock of a system central processing unit.

16. The terminal according to claim 9, wherein determining whether to check and kill the server process by the abnormality checking and killing manager based on the communication timeout notification information and checking and killing conditions, comprises:
determining whether server configuration information exists, the server configuration information comprising a blacklist and/or a whitelist;
in response to that it is determined that the server configuration information exists, obtaining the server configuration information;
determining whether the server process is located in the blacklist;
in response to that the server process is located in the blacklist, checking and killing the server process and restarting the server process;
in response to that the server process is not located in the blacklist, determining whether the server process is located in the whitelist; and
in response to that the server process is not located in the whitelist, determining whether to check and kill the server process based on the communication timeout notification information and the checking and killing conditions.

17. A non-transitory storage medium, being configured for storing program codes which are configured for executing an information processing method,
wherein the information processing method comprises:
notifying an application process of running a component and sending component information to a component running monitoring manager;
in response to that a component running completion notification is not received within a first preset time, sending component running timeout notification information to the application process by the component running monitoring manager;
querying a communication monitoring module about communication information of a key thread of the application process by a communication sub-thread of the application process based on the component running timeout notification information, the communication information comprising a server process responding to communication and a communication time;
in response to that the communication time exceeds a preset threshold, sending communication timeout notification information to an abnormality checking and killing manager by the communication sub-thread; and
determining whether to check and kill the server process by the abnormality checking and killing manager based on the communication timeout notification information and checking and killing conditions.

18. The non-transitory storage medium according to claim 17, wherein the communication monitoring module runs in the application process, and the component running monitoring manager and the abnormality checking and killing manager run in a system server process.

19. The non-transitory storage medium according to claim 17, wherein the component information comprises a component type and a first application process running the component, the communication timeout notification information comprises the communication time, the server process responding to communication, and whether the server process is located in a foreground, and the checking and killing conditions comprise at least one selected from a group consisting of a system load, a running scene of the application process, and whether the server process communicates with other processes.

20. The non-transitory storage medium according to claim 17, wherein the application process sends one component running completion notification to the component running monitoring manager each time after one lifecycle method of the component is executed.
